(19) United States
(12) Patent Application Publication
(10) Pub. No.: US 2026/0369825 A1
(43) Pub. Date: Nov. 19, 2026

(54) ELECTRODE ASSEMBLY AND SECONDARY BATTERY

(71) Applicant: SAMSUNG SDI CO., LTD., Yongin-si (KR)

(72) Inventors: Jun Hwan KWON, Suwon-si (KR); Young Ho KIM, Suwon-si (KR); Jin Hwan KIM, Suwon-si (KR); Young Jae CHO, Suwon-si (KR); Jong Min IM, Suwon-si (KR); Bong Geun KANG, Suwon-si (KR)

(21) Appl. No.: 19/561,763

(22) Filed: Mar. 10, 2026

(30) Foreign Application Priority Data
Mar. 31, 2025 (KR) 10-2025-0041214

(51) Int. Cl. H01M 50/533; H01M 4/04; H01M 4/36; H01M 4/70; H01M 10/0587; H01M 50/474

(52) U.S. Cl. CPC H01M 50/533; H01M 4/0435; H01M 4/0471; H01M 4/364; H01M 4/70; H01M 10/0587; H01M 50/474

(57) ABSTRACT

An electrode assembly includes an electrode and a separator would about a winding axis. The electrode includes a substrate including a first region in which patterns are formed and at least a portion of which is bent toward a core portion of the electrode assembly, and a second region forming a boundary with the first region in a winding direction. A mixture layer is formed in the second region.

### CROSS-REFERENCE TO RELATED APPLICATION

The present application claims priority to and the benefit of Korean Patent Application No. 10-2025-0041214, filed on Mar. 31, 2025, in the Korean Intellectual Property Office, the entire disclosure of which is incorporated herein by reference.

### BACKGROUND

### Technical Field

The present disclosure relates to an electrode assembly and a secondary battery including the electrode assembly.

### Description of the Related Art

With the proliferation of electronic devices using batteries, such as mobile phones, notebook computers, and electric vehicles, the demand for secondary batteries having high energy density and high capacity has increased. Accordingly, research and development has been directed at improving the performance of lithium secondary batteries.

Lithium secondary batteries include a positive electrode and a negative electrode, each of which includes an active material capable of intercalation and deintercalation of lithium ions, and an electrolyte. Such batteries generate electric energy through an oxidation-reduction reaction occurring when lithium ions are intercalated/deintercalated into/from the positive electrode and the negative electrode.

The information disclosed in this section is intended to aid in the understanding of the background of the present disclosure and thus may include information that is not prior art.

### SUMMARY

The present disclosure is directed at providing an electrode assembly with improved electrolyte impregnation, and a secondary battery including the electrode assembly.

The present disclosure is also directed at providing an electrode assembly having a substrate with improved processing quality, and a secondary battery including the electrode assembly.

However, the problems to be solved by the present disclosure are not limited to the above-described problems, and other problems solved by the present disclosure that are not mentioned will be clearly understood by those skilled in the art from the following description.

According to an aspect of the present disclosure, there is provided an electrode assembly formed by winding an electrode and a separator wound about a winding axis, wherein the electrode may include a substrate including a first region, on which patterns are formed and at least a portion of which is bent toward a core portion of the electrode assembly, and a second region forming a boundary with the first region in a winding direction, and a mixture layer formed on the second region.

The patterns may include a plurality of grooves formed into a surface of the substrate.

The first region may include a plurality of notches each extending in a direction perpendicular to the winding axis and having widths in the winding direction, and at least some of the notches may be bent toward the core portion.

The plurality of notches may include a plurality of first notches adjacent to the core portion and each having a first width in the winding direction, a plurality of second notches each having a second width in the winding direction that is greater than the first width, and a plurality of third notches adjacent to an outermost portion of the electrode and each having a third width greater in the winding direction that is greater than the second width.

A spacing between the patterns in the second notches is greater than a spacing between the patterns in the first notches, and a spacing between the patterns in the third notches is greater than a spacing between the patterns in the second notches.

The patterns may in each of the notches 50% or more and 75% or less of the area of each of the notches.

Each of the patterns may be formed in a region corresponding to ½ or less of a total area from an end portion of each of the notches to the boundary.

The first region may include a standing portion extending in a direction of the winding axis, and a bent portion connected to the standing portion and extending in a different direction from the standing portion, and the patterns may be formed on the bent portion.

The patterns may be formed on at least one of the substrate and the mixture layer.

The electrode may further include an insulating layer formed on the mixture layer along the boundary, and the patterns may be formed on at least one of the substrate, the mixture layer, and the insulating layer.

A density of the patterns may be greater in at least one of the substrate and the mixture layer than a density of the patterns in the insulating layer.

The patterns may be formed by at least one of a rolling process, a laser process, and a heat treatment process.

According to another aspect of the present disclosure, there is provided a secondary battery including a case and an electrode assembly accommodated in the case, the electrode assembly comprising an electrode and a separator wound about a winding axis, and an electrolyte impregnated into the electrode assembly, wherein the electrode may include a substrate including a first region, in which patterns are formed and at least a portion of which is bent toward a core portion of the electrode assembly, and a second region forming a boundary with the first region in a winding direction, and a mixture layer formed in the second region.

The patterns may include a plurality of grooves formed into a surface of the substrate, and the electrolyte may form a contact angle of less than 90° with the substrate on each of the grooves.

The first region may include a plurality of notches extending in a direction perpendicular to the winding axis having widths in the winding direction, and at least some of the notches may be bent toward the core portion.

The plurality of notches may include a plurality of first notches adjacent to the core portion and each having a first width in the winding direction, a plurality of second notches each having a second width in the winding direction that is greater than the first width, and a plurality of third notches adjacent to an outermost portion of the electrode and each having a third width greater in the winding direction than the second width.

The secondary battery may further include a current collector located at a side of the electrode assembly, the current collector being electrically connected to the substrate, and configured to collect current from the electrode, wherein the current collector may be joined to the second notches.

Each of the patterns in each of the notches may be 50% or more and 75% or less of an area of each of the notch.

Each of the patterns may be formed in a region corresponding to ½ or less of a total area from an end portion of each of the plurality of notches to the boundary.

The first region may include a standing portion extending in a direction of the winding axis, and a bent portion connected to the standing portion and extending in a different direction from the standing portion, and the patterns may be formed on the bent portion.

### BRIEF DESCRIPTION OF THE DRAWINGS

The drawings illustrate exemplary embodiments of the present disclosure, and the spirit of the present disclosure will be more clearly understood from the accompanying drawings together with the following description. But the present disclosure is not limited to the embodiments depicted in the drawings.

FIG. 1 is a perspective view of a battery pack according to an embodiment of the present disclosure;

FIG. 2 is a plan view of a configuration of the battery pack according to an embodiment of the present disclosure;

FIG. 3 is a perspective view of a configuration of a secondary battery according to an embodiment of the present disclosure;

FIG. 4 is a cross-sectional view of a configuration of a secondary battery according to an embodiment of the present disclosure;

FIG. 5 is a view schematically illustrating an electrode assembly according to an embodiment of the present disclosure;

FIG. 6 is a view of an electrode according to an embodiment of the present disclosure;

FIG. 7 is a view of an electrolyte located on a pattern according to an embodiment of the present disclosure;

FIG. 8 is a view of an electrode according to an embodiment of the present disclosure;

FIG. 9 is a view of a comparison of notches by sections according to an embodiment of the present disclosure;

FIG. 10 is a view of an example in which patterns are formed on the notches according to an embodiment of the present disclosure;

FIG. 11 is a view of an example in which a first region is bent according to an embodiment of the present disclosure;

FIG. 12 is a view of a configuration of a first electrode according to an embodiment of the present disclosure; and

FIG. 13 is a view of a configuration of a second electrode according to an embodiment of the present disclosure.

### DETAILED DESCRIPTION

Hereinafter, exemplary embodiments of the present disclosure will be described in detail with reference to the accompanying drawings. The terms or words used in the present specification and claims should not be construed as being limited to ordinary or dictionary meanings and should be construed with meanings and concepts consistent with the technical spirit of the present disclosure based on the principle that an inventor can appropriately define concepts and terms to explain their invention in the best way. Therefore, the embodiments described herein and the configurations illustrated in the drawings are only some of the most preferred embodiments and are not representative of the full technical spirit of the present disclosure, and thus it should be understood that various equivalents and modifications may be made at the time of filing of the present application.

When used in the present specification, “comprise/include” and/or “comprising/including” may specify the presence of described shapes, numbers, steps, operations, members, elements, and/or groups thereof and may not exclude the presence or addition of one or more other shapes, numbers, steps, operations, members, elements, and/or groups thereof.

To help with understanding of the disclosure, the accompanying drawings may not be illustrated in actual scales. Rather, sizes of some components may be exaggerated. In addition, the same reference numerals may be assigned to the same components in different embodiments.

The description that two objects for comparison are “the same” as each other may denote that they are “substantially the same” as each other. Thus, the range of the expression “substantially the same” may include a case of having a deviation considered as a low degree, for example, a deviation within 5%. In addition, the description that a certain parameter is the same in a certain region may denote that the parameter is the same from an average perspective.

Terms including ordinals such as “first” and “second” may be used to describe various components, but, of course, the components are not limited by the terms. These terms are merely used to distinguish one component from another. Unless particularly described otherwise, a first component may also be a second component.

Throughout the specification, unless particularly described otherwise, each component may be provided in a singular number or a plural number.

Arrangement of any configuration on an “upper portion (or lower portion)” of a component or “on (or below)” the component may mean not only that the configuration may be disposed in contact with an upper surface (or lower surface) of the component but also that another configuration may be interposed between the component and the configuration disposed on (or below) the component.

When it is described that a component is “on,” “connected to,” or “coupled to,” another component, these components may be directly connected or coupled to each other, but it should be understood that still another component may be “interposed” between these components, or these components may be “connected,” “coupled,” or “joined” through still another component.

As used herein, the term “and/or” includes any and all combinations of one or more of the associated listed items. Further, when describing embodiments of the present disclosure, the use of “may” means one or more embodiments of the present disclosure. When preceding a list of elements, the terms “one or more” and “at least one” modify the entire list of elements and do not modify the individual elements of the list.

The expression “A and/or B” throughout the specification means A, B, or A and B, unless stated otherwise. The expression “C to D” means C or more and D or less, unless otherwise specified.

When a phrase such as “at least one of A, B and C,” “at least one of A, B or C,” “at least one selected from the group of A, B and C,” or “at least one selected from among A, B and C” are used to designate a list of elements A, B and C, the phrase may refer to any and all suitable combinations or subsets of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms “first,” “second,” “third,” and the like may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the figures. For example, when the device in the drawing is turned over, elements described as “below” or “beneath” other elements would then be oriented “above” or “over” the other elements. Thus, the term “below” may encompass both an orientation of above and below.

The terms used in the present specification are intended to describe embodiments of the present disclosure and are not intended to limit the present disclosure.

In the present disclosure, an x-axis represents a first direction. For example, the first direction (x-axis) includes a longitudinal direction of an electrode. A y-axis represents a second direction. The second direction (y-axis) is perpendicular to the first direction (x-axis). For example, the second direction (y-axis) includes a thickness direction of the electrode. A z-axis represents a third direction. The third direction (z-axis) is perpendicular to both the first direction (x-axis) and the second direction (y-axis). For example, the third direction (z-axis) includes a direction in which a rotational axis of an electrode assembly extends.

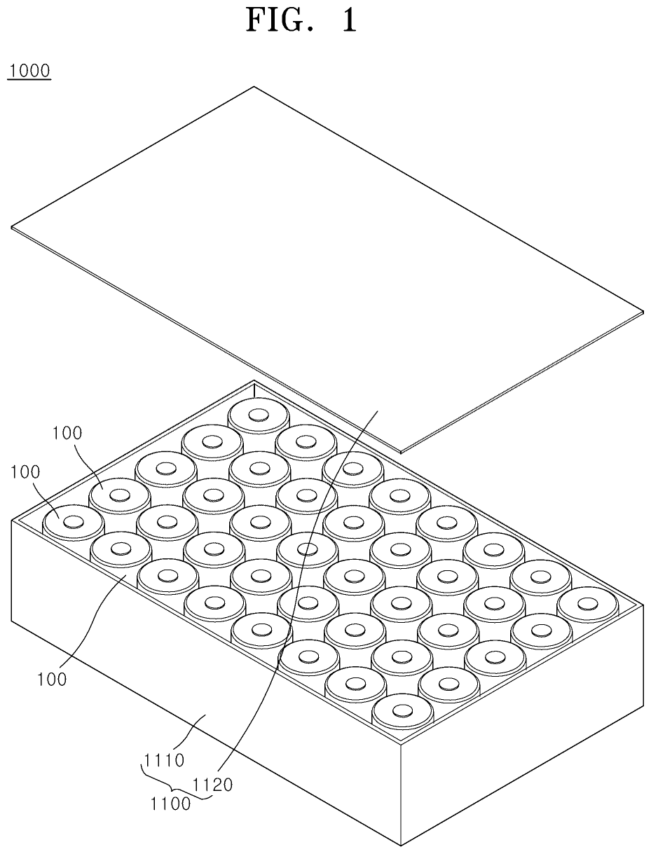

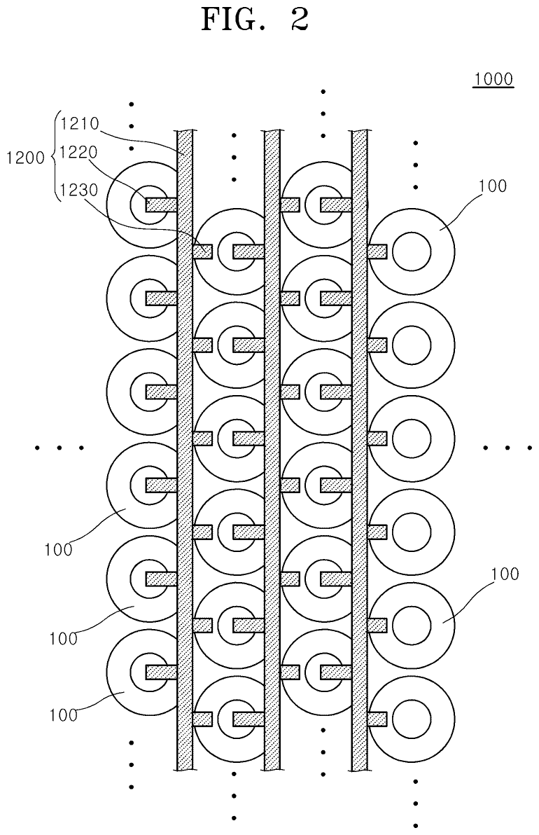

FIG. 1 is a perspective view of a battery pack according to an embodiment of the present disclosure. FIG. 2 is a plan view of the battery pack.

Referring to FIGS. 1 and 2, a battery pack 1000 according to various embodiments of the present disclosure may include a housing 1100, a secondary battery 100, and a bus bar 1200. The housing 1100 forms an exterior of the battery pack, and the housing 1100 may provide a space in which the secondary battery 100 may be accommodated. The housing 1100 according to the present embodiment may include a housing body 1110 and a cover 1120.

The housing body 1110 may be box shaped with an open interior space and an open side. A cross-sectional shape of the housing body 1110 is not limited to the quadrangular shape shown in FIG. 1 and may be various other shapes such as a polygonal shape, a circular shape, and an oval shape.

The cover 1120 may be coupled to the housing body 1110 and may close the open internal space of the housing body 1110. As an example, the cover 1120 may be formed to have substantially a plate shape and may be disposed to face the open side of the housing body 1110. The cover 1120 may be fixed to the housing body 1110 by various types of coupling methods such as bolting, welding, and fitting.

The secondary battery 100 may function as a unit structure, which stores and supplies power in the battery pack 1000. As such, a plurality of secondary batteries 100 may be provided. The plurality of secondary batteries 100 may be positioned in the housing 1100 in various patterns, such as a grid shape and a zigzag shape. The plurality of secondary batteries 100 may be arranged side by side. The number of secondary batteries 100 may vary depending on the size, shape, or the like of the housing 1100. Detailed configurations of each of the secondary batteries will be described below.

The bus bar 1200 may electrically connect the plurality of secondary batteries 100. The plurality of secondary batteries 100 may be connected in series or in parallel by the bus bar 1200. As an example, the bus bar 1200 may connect the secondary batteries 100 disposed in the same row within the housing 1100 in parallel, and the bus bar 1200 may connect the secondary batteries 100 disposed in two adjacent rows in series. The bus bar 1200 may be formed of an electrically conductive material such as copper, aluminum, nickel, or the like.

Referring to FIG. 2, the bus bar 1200 according to the present embodiment may include a main bus bar 1210, a first branch bus bar 1220, and a second branch bus bar 1230.

The main bus bar 1210 may be disposed between adjacent rows of the secondary batteries 100. A plurality of main bus bars 1210 may be provided. The main bus bars 1210 may extend linearly between the rows of the secondary batteries 100, or the main bus bars 1210 may be bent into a zigzag shape. The main bus bars 1210 may be individually disposed between different adjacent rows of the secondary batteries 100. The main bus bars 1210 may be electrically connected to each other.

The first branch bus bar 1220 may extend from the main bus bar 1210 toward a rivet of the secondary battery 100. The first branch bus bar 1220 may be mechanically and electrically connected to the rivet by laser welding, ultrasonic welding, or the like.

The second branch bus bar 1230 may extend from the main bus bar 1210 toward a case of the secondary battery 100. The second branch bus bar 1230 may be mechanically and electrically connected to the case by laser welding, ultrasonic welding, or the like.

Hereinafter, the secondary battery 100 according to an embodiment of the present disclosure will be described.

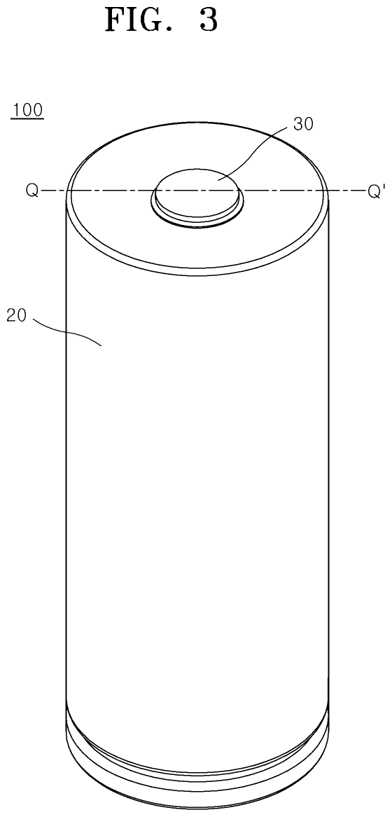

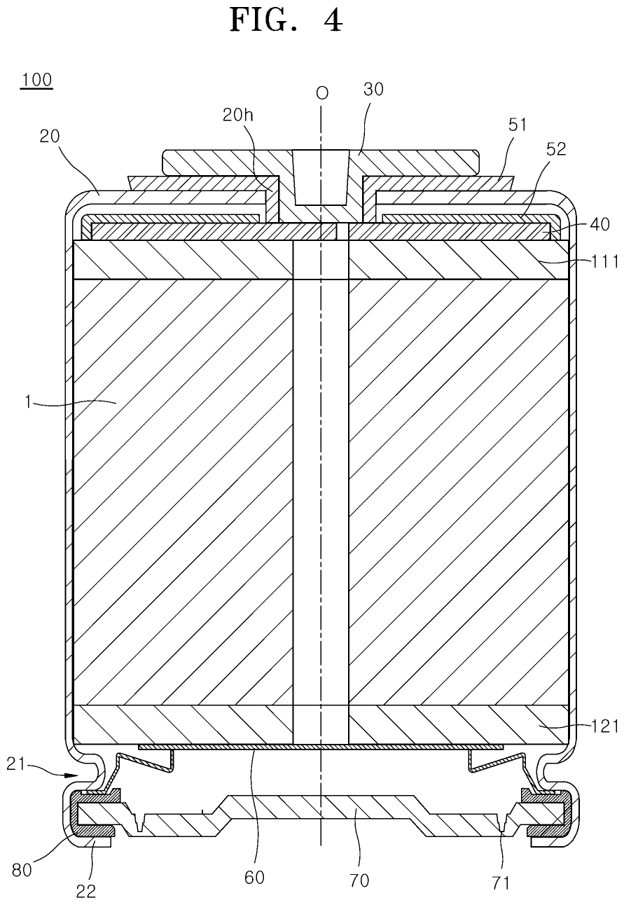

FIG. 3 is a perspective view of a secondary battery according to an embodiment of the present disclosure. FIG. 4 is a cross-sectional view of a secondary battery according to an embodiment of the present disclosure.

Referring to FIGS. 3 and 4, a secondary battery 100 (which may be the secondary battery 100 described with reference to FIGS. 1 and 2) includes an electrode assembly 1, a case 20 in which the electrode assembly 1 is accommodated, and an electrolyte that is injected into the case 20 and impregnates the electrode assembly 1.

The secondary battery 100 may further include a rivet 30 that is inserted into a hole 20h formed in a surface of the case 20 and is electrically connected to the electrode assembly 1. The secondary battery 100 also includes a cap plate 70 that covers an opening formed on another surface of the case 20. However, the components of the secondary battery 100 are not limited to those illustrated in FIGS. 3 and 4, and the secondary battery 100 may include only some of the components shown in FIGS. 3 and 4 and/or may further include other components that are not shown in FIGS. 3 and 4.

Hereinafter, a case in which the secondary battery 100 is a lithium ion secondary battery and has a cylindrical shape will be described as an example. However, the present disclosure is not limited to such a configuration. In other embodiments, the secondary battery may be a lithium-polymer battery or a prismatic battery.

The electrode assembly 1 may function as a unit structure for performing a power charging and discharging operation in the secondary battery 100.

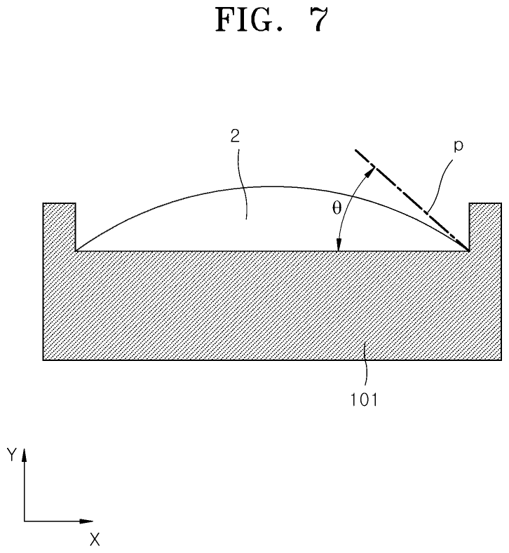

The case 20 accommodates the electrode assembly 1. The case 20 seals the accommodated electrode assembly 1 together with an electrolyte 2 (see FIG. 7). For example, the case 20 may be sealed by the cap plate 70. The case 20 forms the exterior of the secondary battery 100. The case 20 includes an upper surface that forms an upper portion of the cylindrical shape and a side surface that is connected to an outer circumferential surface of the upper surface and extends vertically downward from the upper surface.

The hole 20h may be formed in the upper surface of the case 20. The hole 20h is formed to extend through the upper surface of the case 20. The hole 20h may be located at the center of the upper surface of the case 20. For example, the hole 20h may be formed at a position that is vertically above a core portion of the electrode assembly 1 and the ground. The shape of the hole 20h may correspond to the shape of the rivet 30. For example, when a cross section of the rivet 30 has a circular shape, a cross section of the hole 20h may also be formed in a circular shape. In this configuration, a diameter of the cross section of the hole 20h is greater than a diameter of the cross section of the rivet 30.

The cylindrical case 20 may have an open lower portion. The inside of the case 20 may be sealed by closing the opening with the cap plate 70. Accordingly, the case 20 may sealed such that the electrolyte does not leak to the outside and the electrode assembly 1 is protected in the case 20.

The case 20 may be formed of, for example, steel, stainless steel, aluminum, an aluminum alloy, a combination thereof, or an equivalent material.

The secondary battery 100 may further include a gasket 80 to ensure more reliable sealing of the case 20. The gasket 80 may be formed, for example, in a ring shape. The gasket 80 may be positioned between the cap plate 70 and an inner circumferential surface of the case 20 while surrounding an outer circumferential surface of the cap plate 70. As such, the gasket 80 may prevent the electrolyte inside the secondary battery 100 from leaking and causing safety issues.

A beading part 21 may be formed in the case 20 to fix the position of the cap plate 70 with respect to the opening of the case 20. For example, the beading part 21 is formed on a lower portion of the case 20. The beading part 21 may be formed by the case 20 being indented inward from the outside. The beading part 21 may prevent the cap plate 70 from being further inserted into the case 20. A crimping part 22 may be further formed in the case 20 to fix the position of the cap plate 70 with respect to the opening of the case 20. The crimping part 22 may be formed by curling an end portion of the case 20 at the opening toward the inside of the case 20. For example, the crimping part 22 may be formed by bending the end portion of the case 20 toward the inside of the case 20 after the cap plate 70 is placed at the opening of the case 20. Thus, the cap plate 70 may cover the opening of the case 20.

The cap plate 70 may also function as a vent. For example, the cap plate 70 may include a groove 71. The groove 71 may rupture when an internal pressure or temperature of the case 20 increases. Gas may be released from the inside of the case 20 through the ruptured groove 71.

The case 20 is electrically connected to the electrode assembly 1 accommodated inside the case 20. For example, the case 20 is electrically connected to a second electrode 12. The second electrode 12 may be, for example, a negative electrode.

The secondary battery 100 may further include a second current collector 60 located below the electrode assembly 1 to electrically connect the case 20 to the second electrode 12. The second current collector 60 may be located between a lower portion of the electrode assembly 1 and an upper portion of the cap plate 70. The second current collector 60 and the cap plate 70 may be insulated from each other by the gasket 80. The second current collector 60 may be, for example, a negative electrode current collector. The second current collector 60 is connected to the second electrode 12. In particular, the second current collector 60 is connected to a tab of the second electrode 12. The second current collector 60 is also connected to the case 20. Accordingly, the case 20 may be electrically connected to the second electrode 12 and may have the same polarity as the second electrode 12. That is, the case 20 may have a negative polarity.

The rivet 30 is inserted into the hole 20h formed in the upper surface of the case 20 and electrically connected to the electrode assembly 1 accommodated inside the case 20. In particular, the rivet 30 is electrically connected to a first electrode 11. The first electrode 11 may be, for example, a positive electrode.

The secondary battery 100 may further include a first current collector 40 located above the electrode assembly 1 to electrically connect the rivet 30 to the first electrode 11. The first current collector 40 may be, for example, a positive electrode current collector that is connected to the first electrode 11. In particular, the first current collector 40 is connected to a tab of the first electrode 11. The first current collector 40 is also connected to the rivet 30. Through this, the rivet 30 is electrically connected to the first electrode 11 and may have the same polarity as the first electrode 11. Thus the rivet 30 may have a positive polarity.

The rivet 30 may include a conductive material to be electrically connected to the first electrode 11. For example, the rivet 30 may include a metal. In a specific example, the rivet 30 may include aluminum (Al).

The secondary battery 100 may further include a rivet gasket 51. The rivet gasket 51 may be located between the rivet 30 and the case 20, and the rivet gasket 51 may insulate between the case 20 and the rivet 30. When viewed from above, the rivet gasket 51 may be formed to have a larger area than the rivet 30. For example, the rivet gasket 51 may be formed along an inner circumferential surface of the hole 20h at an upper portion of the case 20. The rivet gasket 51 may be formed of an insulating material such as rubber, polyethylene (PE), polypropylene (PP), or polyethylene terephthalate (PET).

The secondary battery 100 may further include an insulating layer 52. The insulating layer 52 may be provided on the first current collector 40. The insulating layer 52 prevents the first current collector 40 and the case 20 from being electrically connected to each other.

With this configuration, the secondary battery 100 according to one embodiment of the present disclosure may have an improved capacity by eliminating an upper beading part. In addition, by positioning the cap plate 70 at a lower portion of the secondary battery 100, safety problems that may arise when the secondary battery 100 explodes upward may be resolved.

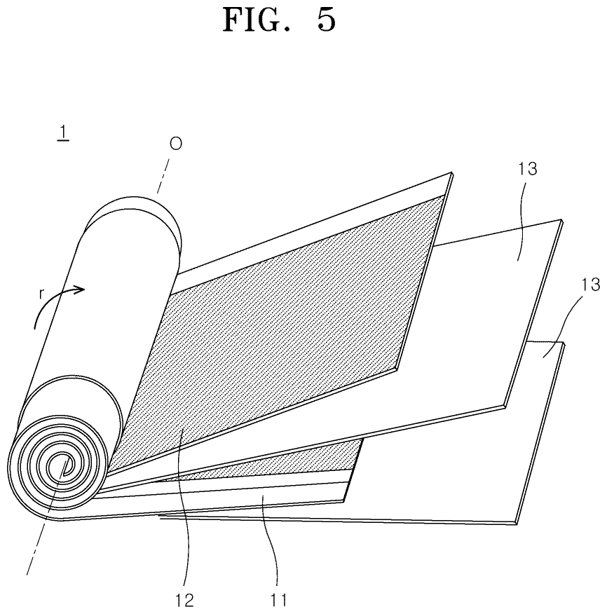

FIG. 5 is a view of a configuration of an electrode assembly according to an embodiment of the present disclosure.

An electrode assembly 1 according to an embodiment of the present disclosure (which may be the electrode assembly 1 described with reference to FIGS. 3 and 4) is formed by winding an electrode 10 and a separator 13 around a winding axis O in a winding direction r. The electrode 10 includes a first electrode 11 and a second electrode 12. The first electrode 11 is a positive electrode or a negative electrode. The second electrode 12 is a negative electrode or a positive electrode and has a polarity opposite to the polarity of the first electrode 11.

The separator 13 may prevent the first electrode 11 and the second electrode 12 from contacting each other and may thereby prevent a short circuit from occurring between the first electrode 11 and the second electrode 12.

The electrode assembly 1 may be formed by stacking the first electrode 11, the second electrode 12, and the separator 13 provided between the first electrode 11 and the second electrode 12. When the electrode assembly 1 is formed in a cylindrical shape, the first electrode 11, the second electrode 12, and the separator 13 may be wound in the winding direction r to form a jelly-roll structure. The winding direction r may include a clockwise direction or a counterclockwise direction. A cross-sectional shape of the electrode assembly 1 may be various shapes such as an elliptical shape, a polygonal shape, or the like in addition to a circular shape. The winding axis O may be a straight line passing through a central portion of the electrode assembly 1.

Detailed descriptions of each component of the electrode assembly 1 are provided below.

### Positive Electrode Active Material

As the positive electrode active material, a compound that is capable of reversible intercalation and deintercalation of lithium (a lithiated intercalation compound) may be used. Specifically, one or more of composite oxides of lithium and a metal selected from cobalt, manganese, nickel, and a combination thereof may be used.

The composite oxide may be a lithium-transition metal composite oxide. Specific examples include a lithium nickel-based oxide, a lithium cobalt-based oxide, a lithium manganese-based oxide, a lithium iron phosphate-based compound, a cobalt-free nickel-manganese-based oxide, or a combination thereof. As examples, compounds represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8). In these chemical formulas, A is Ni, Co, Mn, or a combination thereof; X is Al, Ni, Co, Mn, Cr, Fe, Mg, Sr, V, a rare-earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be a high-nickel-based positive electrode active material having a nickel amount of greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of the metal excluding lithium in the lithium-transition metal composite oxide. The high-nickel-based positive electrode active material may be capable of providing high capacity and can be used in high-capacity and high-density lithium batteries.

### Positive Electrode

The positive electrode for the secondary battery 100 may include a current collector and a positive electrode mixture layer formed on the current collector. The positive electrode mixture layer includes a positive electrode active material and may further include a binder and/or a conductive material. The positive electrode may further include an additive that can serve as a sacrificial positive electrode.

A amount of the positive electrode active material may range from 90 wt % to 99.5 wt % based on 100 wt % of the positive electrode mixture layer. An amount of each of the binder and the conductive material may range from 0.5 wt % to 5 wt % based on 100 wt % of the positive electrode mixture layer.

The binder serves to adhere positive electrode active material particles to each other and also to adhere the positive electrode active material to the current collector. Representative examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like. But the present disclosure is not limited to these examples.

The conductive material is used to provide conductivity to the electrode, and any material that does not cause an undesirable chemical change in a battery and is electrically conductive may be used. Examples of the conductive material include a carbon-based material such as natural graphite, artificial graphite, carbon black, acetylene black, Ketjen black, carbon fibers, carbon nanofibers, or carbon nanotubes; a metal-based material in the form of a metal powder or metal fiber including copper, nickel, aluminum, silver, or the like; a conductive polymer such as a polyphenylene derivative; or a mixture thereof.

Aluminum may be used as the current collector. But the present disclosure is not limited to aluminum.

### Negative Electrode Active Material

The negative electrode active material includes a material that can reversibly intercalate/deintercalate lithium ions, a lithium metal, a lithium metal alloy, a material capable of doping and dedoping lithium, or a transition metal oxide.

The material capable of reversible intercalation and deintercalation of lithium ions may be a carbon-based negative electrode active material. The material may include, for example, crystalline carbon, amorphous carbon, or a combination thereof. Examples of the crystalline carbon may include graphite such as amorphous, plate-shaped, flaky, spherical, or fibrous natural graphite or artificial graphite. Examples of the amorphous carbon may include soft carbon or hard carbon, a mesophase pitch carbonized product, calcined coke, and the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

A Si-based negative electrode active material or a Sn-based negative electrode active material may be used as the material capable of doping and dedoping lithium. The Si-based negative electrode active material may include silicon, a silicon-carbon composite, SiOₓ (0<x<2), a Si-Q alloy, or a combination thereof. In the formula Si-Q, Q is selected from an alkali metal, an alkaline-earth metal, a Group 13 element, a Group 14 element (excluding Si), a Group 15 element, a Group 16 element, a transition metal, a rare-earth element, and a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on the surfaces of the silicon particles. For example, the silicon-carbon composite may include secondary particles (core) in which silicon primary particles are agglomerated and an amorphous carbon coating layer (shell) is formed on the surfaces of the secondary particles. The amorphous carbon may also be located between the silicon primary particles such that the silicon primary particles are coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or the Sn-based negative electrode active material may be used by being mixed with a carbon-based negative electrode active material.

### Negative electrode

The negative electrode for the secondary battery 100 includes a current collector and a negative electrode mixture layer located on the current collector. The negative electrode mixture layer includes a negative electrode active material and may further include a binder and/or a conductive material. The negative electrode mixture layer may include, for example, 90 wt % to 99 wt % of the negative electrode active material, 0.5 wt % to 5 wt % of the binder, and 0 wt % to 5 wt % of the conductive material.

The binder serves to adhere negative electrode active material particles to each other and also to adhere the negative electrode active material to the current collector. A non-aqueous binder, an aqueous binder, a dry binder, or a combination thereof may be used as the binder.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be styrene-butadiene rubber, (meth)acrylated styrene-butadiene rubber, (meth)acrylonitrile-butadiene rubber, (meth)acrylic rubber, butyl rubber, fluororubber, a polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, or a combination thereof.

When the aqueous binder is used as the negative electrode binder, a cellulose-based compound capable of imparting viscosity can be included. As the cellulose-based compound, one or more of carboxymethyl cellulose, hydroxypropylmethyl cellulose, methyl cellulose, or alkali metal salts thereof may be used in combination. Na, K, or Li can be used as the alkali metal.

The dry binder is a polymer material capable of being fiberized, and may be, for example, polytetrafluoroethylene, polyvinylidene fluoride, a polyvinylidene fluoride-hexafluoropropylene copolymer, a polyethylene oxide, or a combination thereof.

The conductive material is used to provide conductivity to the electrode, and any material that does not cause an undesirable chemical change in a battery and is electrically conductive may be used in the configured battery. Specific examples of the conductive material may include a carbon-based material such as natural graphite, artificial graphite, carbon black, acetylene black, Ketjen black, carbon fibers, or carbon nanofibers; a metal-based material in the form of a metal powder or metal fiber including copper, nickel, aluminum, silver, or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

### Separator

Depending on the type of the secondary battery 100, the separator 13 may be present between the first electrode 11 and the second electrode 20. The separator 13 may include polyethylene, polypropylene, polyvinylidene fluoride, or a multilayer film of two or more layers thereof, and of course, may also include a mixed multilayer film such as a polyethylene/polypropylene two-layer separator, a polyethylene/polypropylene/polyethylene three-layer separator, a polypropylene/polyethylene/polypropylene three-layer separator, or the like.

The separator 13 may include a porous substrate, and a coating layer including an organic material, an inorganic material, or a combination thereof located on one surface or both surfaces of the porous substrate.

The porous substrate may be a polymer film formed of any one polymer selected from polyolefins such as polyethylene, polypropylene, and the like, polyesters such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, glass fibers, TEFLON®, and polytetrafluoroethylene, or a copolymer or mixture of two or more.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic and inorganic materials may be present by being mixed in one coating layer. In another embodiment, the organic and inorganic materials may be present in a form in which a coating layer including organic materials and a coating layer including inorganic materials are stacked.

### Electrolyte

The electrolyte for the secondary battery 100 includes a non-aqueous organic solvent and a lithium salt.

The non-aqueous organic solvent serves as a medium through which ions involved in the electrochemical reaction of a battery can move. The non-aqueous organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, valerolactone, caprolactone, and the like. In other examples, the ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethyl alcohol, isopropyl alcohol, and the like, and the aprotic solvent may include nitriles such as R—CN (where R is a C2 to C20 linear, branched, or cyclic hydrocarbon group and includes a double bond, an aromatic ring, or an ether bond), and the like; amides such as dimethyl formamide; dioxolanes such as 1,3-dioxolane and 1,4-dioxolane; sulfolanes; and the like.

The non-aqueous organic solvents may be used alone or in combinations of two or more. In addition, when the carbonate-based solvent is used, a cyclic carbonate and a chain carbonate may be mixed and used, and the cyclic carbonate and the chain carbonate may be mixed in a volume ratio of 1:1 to 1:9.

The lithium salt is dissolved in the organic solvent and serves as a source of lithium ions in a battery, enables a basic operation of a lithium battery, and improves the movement of the lithium ions between positive and negative electrodes. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂_{^{x+}}₁SO₂)(C_{Y}F_{2Y}_{⁺}₁SO₂) (where x and y are integers of 1 to 20), lithium trifluoromethanesulfonate, lithium tetrafluoroethanesulfonate, lithium difluorobis(oxalato)phosphate (LiDFOB), and lithium bis(oxalato)borate (LiBOB).

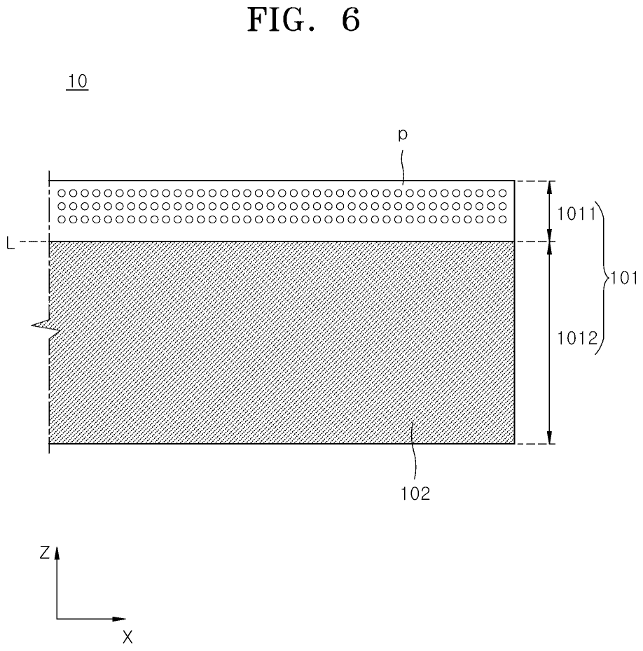

FIG. 6 is a view of an electrode according to an embodiment of the present disclosure. FIG. 7 is a view of an electrolyte located on a pattern according to an embodiment of the present disclosure.

An electrode assembly 1 according to an embodiment of the present disclosure is formed by winding an electrode 10 and a separator 13 around a winding axis O. The electrode 10 includes a substrate 101 including a first region 1011 in which patterns p are formed and at least a portion of which is bent toward a core portion, and a second region 1012 that forms a boundary L with the first region 1011 in a winding direction r. A mixture layer 102 is formed on the second region 1012.

Here, a region of the substrate 101 in which the mixture layer 102 is provided is referred to as a coated portion. A region of the substrate 101 in which the mixture layer 102 is not provided is referred to as an uncoated portion.

The substrate 101 includes the current collector described above. For example, when the electrode 10 corresponds to a positive electrode, the substrate 101 includes a positive electrode current collector. For example, when the electrode 10 corresponds to a negative electrode, the substrate 101 includes a negative electrode current collector.

The first region 1011 and the second region 1012. may be formed to have the same thickness and/or formed from the same material, and a separate boundary line may not be formed between the first region 1011 and the second region 1012. But the present disclosure is not limited in this regard.

In an example where the electrode 10 is wound around the winding axis O, the first region 1011 and the second region 1012 may form a boundary L that is parallel to the winding direction r. In another example where the electrode 10 is not wound, the first region 1011 and the second region 1012 form a boundary L that is parallel to a first direction (x-axis).

The first region 1011 is a region in which the mixture layer 102 is not provided. That is, the first region 1011 may correspond to an uncoated portion.

When the electrode 10 is wound, the first region 1011 may extend upward or downward from the electrode assembly 1. For example, when a first region of the first electrode 11 extends upward, a first region of the second electrode 12 may extend downward. Alternatively, when the first region of the first electrode 11 extends downward, the first region of the second electrode 12 may extend upward. However, that directions that the first regions extend are not limited thereto. And, in another example, the first region of the first electrode 11 and the first region of the second electrode 12 may extend in the same direction. In such an embodiment, the first region of the first electrode 11 and the first region of the second electrode 12 may be disposed so as not to be in contact with each other.

The second region 1012 is a region in which the mixture layer 102 is provided. That is, the second region 1012 may correspond to a coated portion.

The mixture layer 102 includes the mixture layer described above. For example, when the electrode 10 corresponds to a positive electrode, the mixture layer 102 includes a positive electrode mixture layer. When the electrode 10 corresponds to a negative electrode, the mixture layer 102 includes a negative electrode mixture layer.

The mixture layer 102 is provided on at least one surface of the substrate 101. In an example, the mixture layer 102 is formed from a slurry, with the slurry that forms the mixture layer 102 being coated on at least one surface of the substrate 101. In another example, the mixture layer 102 is formed from a freestanding film, with film forming the mixture layer 102 being attached to at least one surface of the substrate 101.

The mixture layer 102 is provided on at least a portion of the substrate 101, in particular, in the second region 1012. In some examples, the mixture layer 102 may be continuously provided on the substrate 101. In other examples, the mixture layer 102 may be intermittently provided on the substrate 101.

The second region of the first electrode 11 and the second region of the second electrode 12 may be separated by the separator 13. To this end, the separator 13 may be larger than at least one of the second region of the first electrode 11 and the second region of the second electrode 12. And the separator 13 may be larger than both the second region of the first electrode 11 and the second region of the second electrode 12. Thus, the separator 13 may prevent a short circuit from occurring between the first electrode 11 and the second electrode 12.

The first region 1011 may electrically connect the electrode 10 to outside of the battery. For example, as described above with reference to FIGS. 3 and 4, when the secondary battery 100 includes a current collector (e.g., the first current collector 40 or the second current collector 60), the first region 1011 electrically connects the electrode 10 to the current collector. In this configuration, the current collector may collect current from the electrode 10. In other embodiments, the first region 1011 may be directly electrically connected to a terminal. In such a configuration, the terminal is a component that is connected to the electrode 10 and electrically connects the secondary battery 100 to outside of the battery, for example, to a bus bar. The terminal may include the rivet 30, the case 20, or the like, as described but with reference to FIGS. 3 and 4. But the present disclosure is not limited in this regard. Hereinafter, an example will be described in which the first region 1011 is connected to the current collector to electrically connect the electrode 10 to outside of the battery.

The first region 1011 may be connected to the current collector through bonding. For example, the first region 1011 may be bonded to the current collector by laser welding, ultrasonic welding, plasma welding, or the like. When a bonding strength is low, the resistance between the first region 1011 and the current collector may increase. As such, electrical connection between the substrate 101 and the current collector may not be stably achieved. Butto prevent such a problem, at least a portion of the first region 1011 may be bent. For example, in a state in which the electrode 10 is wound around the winding axis O, the first region 1011 may be bent toward a core portion of the electrode assembly 1.

In one example, the entirety of the first region 1011 may be bent toward the core portion of the electrode assembly 1. Alternatively, a portion of the first region 1011 may be bent toward the core portion of the electrode assembly 1, and another portion thereof may remain unbent. Alternatively, a portion of the first region 1011 may be bent toward the core portion of the electrode assembly 1, and another portion thereof may be bent toward an outermost portion of the electrode assembly 1. The manner in which the first region 1011 is bent may be based on the arrangements of the first electrode 11 and the second electrode 12, the structure of the secondary battery 100, and the like. Hereinafter, an example will be described in which the entirety of the first region 1011 is bent toward the core portion of the electrode assembly 1.

Processing quality of the first region 1011 may contribute to improving electrical connection between the substrate 101 and the current collector. The substrate 101 may include patterns p formed in at least a portion thereof to improve and/or enhance such processing quality. For example, the patterns p may be formed in the first region 1011.

In an example, the patterns p may include recessed patterns. Each of the recessed patterns may include a form in which a portion where the pattern p is recessed lower than surrounding portions in the second direction (y-axis). The recessed patterns may include a plurality of grooves formed by being pressed inward from the surface of the substrate 101. FIG. 7 illustrates an example in which the pattern p is a recessed pattern formed inward from the surface. However, the patterns p are not limited to the depicted example. The patterns p may be formed in various forms such as convex patterns, embossing, an uneven structure, or roughness. As such, the patterns p may be referred to by various terms.

Each of the convex patterns includes a form such that a portion where the pattern p is formed is raised above surrounding portions in the second direction (y-axis). For example, the patterns may be embossed such that protrusions and grooves are alternately and continuously formed. The uneven structure includes patterns in which recessed patterns and convex patterns are alternately formed. The surface may be referred to as roughened.

For example, the pattern p may be formed by a rolling process, a laser process, a heat treatment process, or the like. The rolling process may be a process of physically rolling the surface of the substrate 101 using a material such as steel or a poly-based material. The laser process may include irradiating a laser onto the substrate 101. The heat treatment process may involve inducing etching on the substrate 101 through high-temperature heat treatment.

The substrate 101 may have improved processing quality due to the patterns p. For example, by forming the patterns p on the first region 1011, the patterns p may maximize an area of the first region 1011 that can be in contact with the current collector. In addition, the patterns p formed on the first region 1011 may provide a pseudo-welding effect between the first region 1011 and the current collector. And by forming the patterns p on the first region 1011, the first region 1011 may be appropriately bent.

The patterns p may improve impregnation of the substrate with the electrolyte 2. FIG. 7 illustrates an example in which the electrolyte 2 is provided on the substrate 101 in which the patterns p are formed. In FIG. 7, θ represents a contact angle of the electrolyte 2. The contact angle θ is an angle between the surface of the substrate 101 and a tangent line at a contact point between the substrate 101 and the electrolyte 2. The pattern p may be formed so that the contact angle θ falls within a predetermined angular range. For example, the pattern p may be formed to be recessed deeper from the surface in the second direction (y-axis) in order to decrease the contact angle θ. Meanwhile, the pattern p may be formed to an appropriate depth such that the substrate 101 is not penetrated by the pattern p and cause a short circuit between the electrodes 10. In other words, the pattern p may be formed to an appropriate depth in consideration of the target contact angle θ of the electrolyte 2 and the thickness of the substrate 101.

In some embodiments, the contact angle θ formed by the electrolyte 2 on the pattern p may be less than 90°. For example, the contact angle θ formed by the electrolyte 2 on the pattern p may be less than or equal to 80°. In other examples, the contact angle θ formed by the electrolyte 2 on the pattern p may be less than or equal to 60°, or the contact angle θ formed by the electrolyte 2 on the pattern p may be less than or equal to 45°, or the contact angle θ formed by the electrolyte 2 on the pattern p may be less than or equal to 30°.

As the contact angle θ of the electrolyte 2 decreases due to the pattern p, the contact area between the substrate 101 and the electrolyte 2 increases. Accordingly, impregnation of the substrate 101 with the electrolyte 2 may have improved.

The pattern p may be formed in various shapes. For example, the pattern p may be formed in a polygonal shape (e.g., a rectangular shape) or a round shape (e.g., including an elliptical shape or a semicircular shape) on the substrate 101. When the pattern p is formed in a polygonal shape or a circular shape, the pattern p may be easily formed. In addition, the pattern p may maximize a contact area with the electrolyte 2 and/or a contact area with the current collector. However, the shape of the pattern p is not limited in the present disclosure. For example, the pattern p may be formed in a notch shape. Hereinafter, an example will be described in which the pattern p is formed in a circular shape.

As described above with reference to FIGS. 6 and 7, the substrate 101 may have improved processing quality and/or impregnation due to the pattern p. Hereinafter, various examples of the distribution and/or form of the pattern p for improving the processing quality of the substrate 101 will be described.

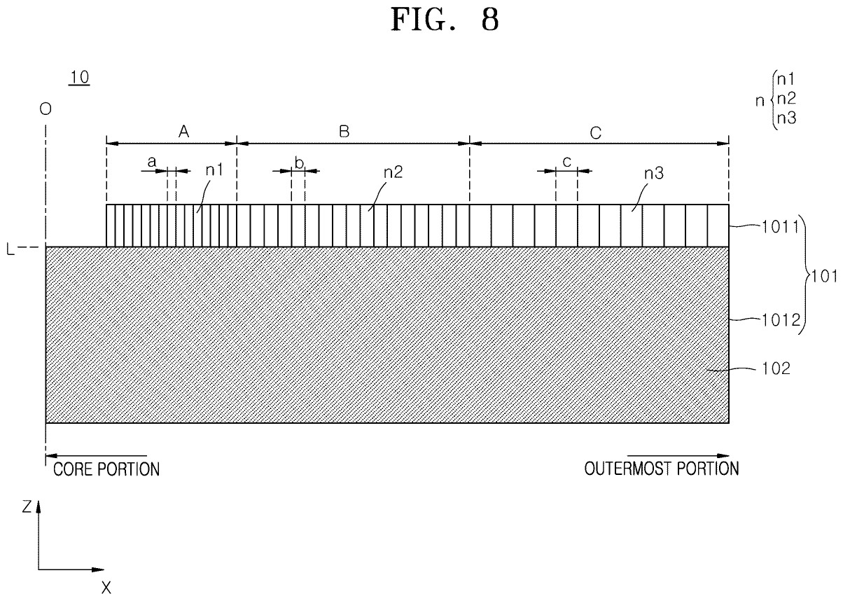

FIG. 8 is a view of an electrode according to one embodiment of the present disclosure.

An electrode assembly may be formed by winding an electrode and a separator around a winding axis O. The electrode includes a substrate 101 and a mixture layer 102.

A first region 1011 is cut in a direction perpendicular to the winding direction r and includes a plurality of notches n that form predetermined widths (e.g., a, b, and c) in the winding direction r. As illustrated in FIG. 8 the first region 1011 may be cut to form the plurality of notches n.

For example, the first region 1011 is cut in the direction perpendicular to the winding direction r in a state in which the electrode 10 is wound. For example, the first region 1011 is cut in a direction parallel to the third direction (z-axis). For example the first region 1011 may be entirely cut from an end portion toward a boundary L in the third direction (z-axis). However, in other embodiments, the first region 1011 may be cut only to an intermediate point toward the boundary L from the end portion. Hereinafter, an example will be described in which the first region 1011 is entirely cut in the third direction (z-axis).

Accordingly, the substrate 101 may include the plurality of notches n formed in the first region 1011. When the notches n extend in the third direction (z-axis), one side of the notch n may be connected to the second region 1012, and the other side thereof may form an end portion. Thus, the plurality of notches n may be connected to each other by the second region 1012, but the end portions of the plurality of notches n may be separately formed.

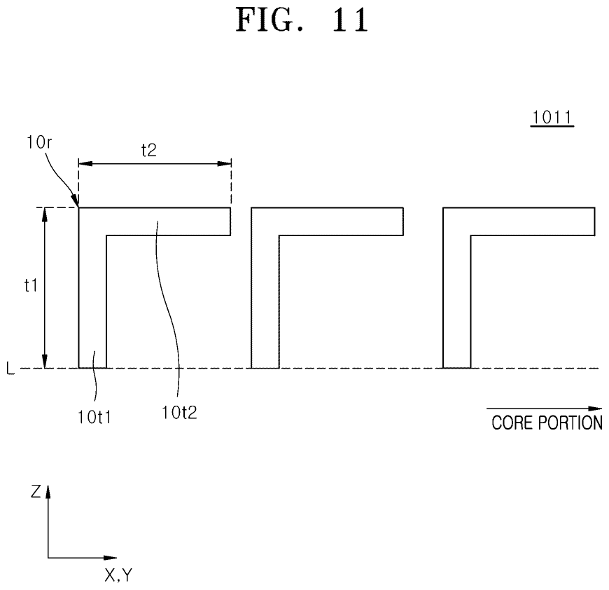

Some of the notches n extending in the third direction (z-axis) may be bent. For example, when the electrode 10 is wound, the notch n may be bent toward a core portion. This configuration will be described in more detail below with reference to FIG. 11.

The notches n may be formed with predetermined widths (e.g., a, b, and c). At least some of the plurality of notches n may be formed to have different widths. In an example, the plurality of notches n may include at least one plurality of first notches n1 adjacent to the core portion and each formed to have a predetermined first width a; a plurality of second notches n2 each formed to have a second width b greater than the first width a; and a plurality of third notches n3 adjacent to an outermost portion and each formed to have a third width c greater than the second width b.

The first region 1011 may include a core section A that is located adjacent to the core portion in a state in which the electrode 10 is wound. The core section A may, for example, include a section within 10 turns in a wound state of the electrode 10. The core section A may include the plurality of first notches n1. Each of the first notches n1 is formed to have the first width a.

The first region 1011 may also include an outermost section C that is located relatively adjacent to the outermost portion when the electrode 10 is wound. The outermost section C may include the plurality of third notches n3. In a state in which the electrode 10 is unfolded, the outermost section C may have the greatest length in the first direction (x-axis) among the sections of the first region 1011. Each of the third notches n3 is formed to have the third width c. The third width c is greater than the first width a.

The first region 1011 may further include a welding section B located between the core portion and the outermost portion in a state in which the electrode 10 is wound. The welding section B may include the plurality of second notches n2. Each of the second notches n2 is formed to have the second width b. The second width b is greater than the first width a and the second width b is less than the third width c.

The welding section B may be joined to a current collector (e.g., including the first current collector 40 and the second current collector 60 described with reference to FIG. 4). For example, the second notches n2 may be joined to the current collector.

The notches n provide a region in which patterns p can be processed. For example, the patterns p may be formed in proportion to a size of each of the notches n. With this configuration, processing quality of the first region 1011 may be improved.

Hereinafter, aspects of the patterns p capable of being formed in the notches n will be described.

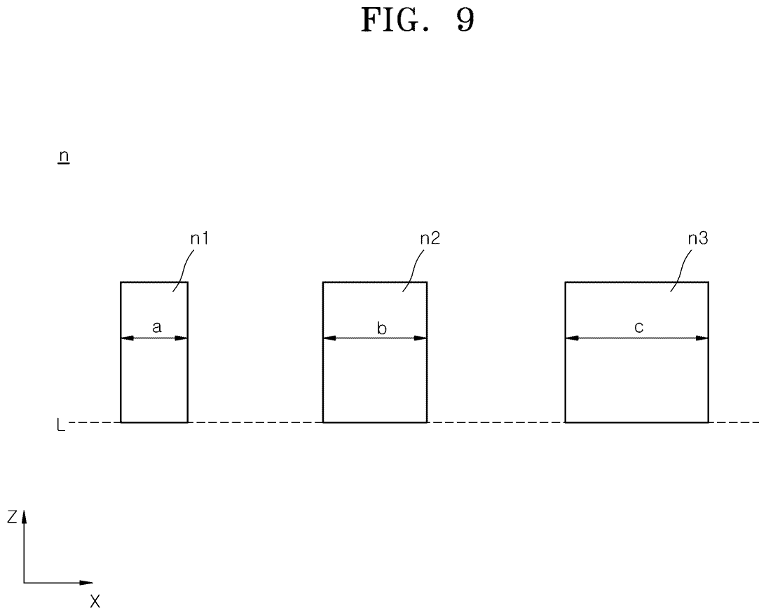

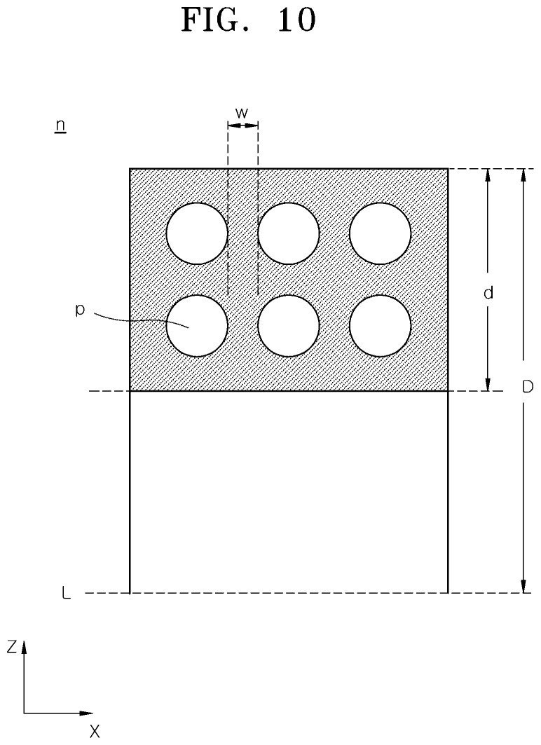

FIG. 9 is a view schematically illustrating notches by sections according to an embodiment of the present disclosure. FIG. 10 is a view of an example in which patterns are formed on the notches according to one embodiment of the present disclosure. FIG. 11 is a view of an example in which a first region is bent according to one embodiment of the present disclosure.

An electrode assembly according to an embodiment of the present disclosure (e.g., including the electrode assembly 1 described with reference to FIGS. 3 to 8) is formed by winding an electrode 10 and a separator 13 around a winding axis O. The electrode 10 includes a substrate 101 and a mixture layer 102.

A first region 1011 is cut in a direction perpendicular to the winding direction r and includes a plurality of notches n that form predetermined widths (e.g., a, b, and c) in the winding direction r. As described with reference to FIG. 8, for example, the first region 1011 includes a core region A, a welding region B, and an outermost region C. In addition, the core region A includes first notches n1, the welding region B includes second notches n2, and the outermost region C includes third notches n3. For convenience, FIG. 9 illustrates one first notch n1, one second notch n2, and one third notch n3 among the plurality of notches n.

FIG. 10 illustrates an example in which the patterns p are formed on the notches n.

In FIG. 10, w represents a spacing between the patterns p. The spacing w between the patterns p is the shortest distance between any pattern (e.g., one groove) and the nearest adjacent pattern (e.g., the nearest groove). Here, the spacing w between the patterns p represents an average value of the spacings between the patterns p. The spacing w between the patterns p may vary depending on a size of the notch n on which the pattern p is formed. The spacing w between the patterns p may be formed in proportion to a width of the notch n.

For example, as illustrated in FIG. 9, the first notch n1 is formed to have a first width a, and the second notch n2 is formed to have a second width b greater than the first width a. Accordingly, in an example, the spacing w between the patterns p may be greater in the second notch n2 than in the first notch n1. Further, the third notch n3 is formed to have a third width c greater than the second width b. Accordingly, in this example, the spacing w between the patterns p may be greater in the third notch n3 than in the second notch n2.

In FIG. 10, D represents a length of the notch n in the third direction (z-axis), and d represents a length in the third direction (z-axis) of a region of the notch n in which the patterns p may be formed, which will hereinafter be referred to as a “pattern processable region”. That is, the pattern processable region is a region of the notch n in which the patterns p are formed, and the patterns p may not necessarily be formed over the entire pattern processable region. Thus, d represents a length of the pattern processable region in the third direction (z-axis).

For example, the pattern processable region may be formed in a range of 50% or more and 75% or less of an area of the notch n. Thus, the patterns p may be formed in a range of 50% or more and 75% or less of the area of each of the plurality of notches n.

The pattern processable region may be formed in proportion to the width of the notch n. In the example illustrated in FIG. 9, the first notch n1 is formed to have the first width a, and the second notch n2 is formed to have the second width b greater than the first width a. Accordingly, the pattern processable region formed in the second notch n2 may be larger than the pattern processable region formed in the first notch n1. Further, the second notch n2 is formed to have the second width b, and the third notch n3 is formed to have the third width c greater than the second width b. Accordingly, the pattern processable region formed in the third notch n3 may be larger than the pattern processable region formed in the second notch n2. With such a configuration, the substrate 101 may improve processing quality.

FIG. 11 illustrates an example in which the first region 1011 is bent. In particular, FIG. 11 illustrates an example in which three notches n are bent, but the embodiment of the present invention is not limited thereto.

In the first region 1011, the notch includes a standing portion 10t1 extending in a direction of the winding axis O (the Z axis direction depicted in FIG. 11), and a bent portion 10t2 connected to the standing portion 10t1 and extending in a direction different from that of the standing portion 10t1. A length of the standing portion 10t1 may be expressed as t1, a length of the bent portion 10t2 may be expressed as t2, and a total length D of the notch n may be expressed as t1+t2.

As described above, the pattern p may be formed in the pattern processable region. In the example depicted in FIG. 11, the pattern processable region may be based on a bending point 10r at which the first region 1011 is bent. Alternatively, the pattern processable region may be formed based a ratio between t1 and t2.

In an example, the pattern processable region may be set so that the patterns p are formed on the bent portion 10t2. Further, t1 and t2 may be formed in a ratio of 1:1 to 1:5, or t1 and t2 may be formed in a ratio of 5:1 to 1:1. The pattern processable region may be set base on such ratios between t1 and t2. And with such a configuration, the substrate 101 may have improved processing quality and/or improved electrolyte impregnation. Hereinafter, the pattern processable region set in consideration of these points will be described.

In an example, in the notch n, the pattern processable region may occupy ½ or less of a total area of the notch n. For example, the length d of the pattern processible region may be ½ or less of the length D of the notch n. In yet another example, in the notch n, the pattern processable region may occupy ⅓ or less of the total area of the notch n. Here, the total area of the notch n is an area from a boundary L to an end portion of the notch n, with the end portion of the notch n being a terminal portion of the notch n in the third direction from the boundary L. For example, the length d of the pattern processible region may be ⅓ or less of the length d of the notch n. Accordingly, the patterns p may be formed in a region corresponding to ½ or less of the total area from the end portion of each of the plurality of notches n to the boundary L. In other embodiments, the patterns p may be formed in a region corresponding to ⅓ or less of the total area from the end portion of each of the plurality of notches n to the boundary L.

In such configurations, the pattern processable region may be formed closer to the end portion of the notch n. For example, in a state in which the electrode 10 is wound, the pattern processable region may be formed closer to the core portion. Because of this, processing of the substrate 101 may be improved.

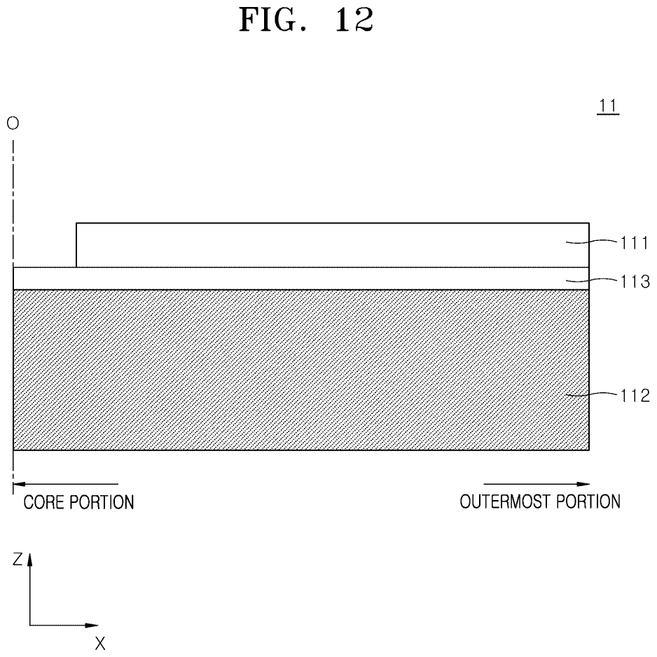

FIG. 12 is a view of a first electrode according to an embodiment of the present disclosure.

An electrode assembly may be formed by winding an electrode and a separator around a winding axis O. The electrode includes a substrate 101 and a mixture layer 102.

In the example depicted in FIG. 12, the electrode includes an insulating layer formed along a boundary L on the mixture layer 112, and patterns p may be additionally formed in at least one of the substrate 101, the mixture layer 112, and the insulating layer 113. A density of the patterns p may be greater in at least one of the substrate and the mixture layer 112 than in the insulating layer 113.

As described above, the first electrode may be a positive electrode. The first substrate 111 of the first electrode may include aluminum (Al). The first mixture layer 112 may include a compound capable of reversibly intercalating and deintercalating lithium (a lithiated intercalation compound). The insulating layer 113 may be formed at a boundary between the first substrate 111 and the first mixture layer 112. In particular, the insulating layer 113 may be formed at a boundary between a coated portion and an uncoated portion of the first electrode 11. The insulating layer 113 may include an insulating material. The insulating material may include, for example, polyamide 6 (PA6), polyimide (PI), polysulfone, polyurethane (PU), polyamide (PA), 6,6 nylon, polycarbonate (PC), polytetrafluoroethylene (PTFE), polymethyl methacrylate (PMMA), or polyethylene terephthalate (PET). As such, the insulating layer 113 may prevent a short circuit from occurring between the first electrode and the second electrode adjacent thereto even when the separator shrinks.

The patterns p may be formed on the first substrate 111. For example, the patterns p may be formed on a first region of the first substrate 111. However, the patterns p may also be formed on a second region of the first substrate 111, and the patterns p may also be formed on the first mixture layer 112.

The patterns p may also be formed on the insulating layer 113. Thus, the insulating layer 113 may improve impregnation with respect to the electrolyte 2. The density of the patterns p may be greater in at least one of the first substrate 111 and the first mixture layer 112 than in the insulating layer 113. For example, in the insulating layer 113, the patterns p may be formed but minimized. As such, the insulating layer 113 may improve impregnation with respect to the electrolyte 2 while preventing a loss of insulating functionality.

Thus, the electrode 10 according to embodiments of the present disclosure may improve processing quality of the substrate (e.g., 111), improve weldability with the current collector (e.g., the first current collector 40), and/or improve impregnation with respect to the electrolyte 2. In addition, the secondary battery 100 according to embodiments of the present disclosure may further improve lifespan, reliability, and/or safety by including the electrode 10.

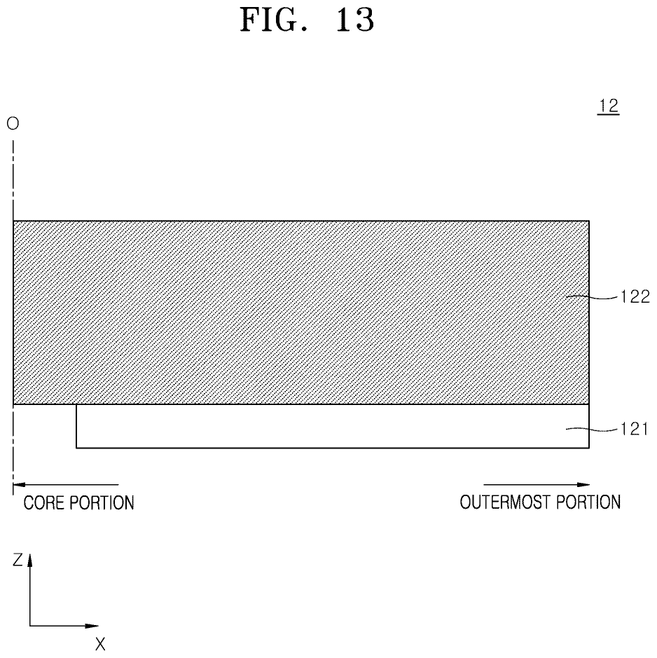

FIG. 13 is a of a second electrode according to an embodiment of the present disclosure.

The second electrode may include a negative electrode. For example, the second electrode 12 may include a second substrate 121 and a second mixture layer 122. The second substrate 121 may include copper (Cu). The second mixture layer 122 may include a material capable of reversibly intercalating and deintercalating lithium ions, a lithium metal, an alloy of a lithium metal, a material capable of doping and dedoping lithium, or a transition metal oxide.

The patterns p may be formed on the second substrate 121. For example, the patterns p may be formed on a first region of the second substrate 121. In other embodiments, the patterns p may also be formed on a second region of the second substrate 121. In further embodiments, the patterns p may also be formed on the second mixture layer 122.

Thus, the electrode according to embodiments of the present disclosure may improve processing quality of the substrate (e.g., 121), improve weldability with the the second current collector 60, and/or improve impregnation with respect to the electrolyte 2. In addition, a secondary battery according to one embodiment of the present invention may further improve lifespan, reliability, and/or safety by including the electrode.

According to the present disclosure, an electrode assembly with improved electrolyte impregnation and/or a secondary battery including the electrode assembly can be provided. According to the present disclosure, an electrode assembly having a substrate with improved processing quality and/or a secondary battery including the electrode assembly can be provided.

However, it will be appreciated by persons skilled in the art that the effects that can be achieved through the present disclosure are not limited to what has been described above and other advantages of the present disclosure will be more clearly understood.

While the disclosure has been described with reference to the exemplary embodiments illustrated in the accompanying drawings, it should be understood that the disclosure is not limited to the disclosed embodiments. Rather, the disclosure covers various modifications and equivalent arrangements.

What is claimed is:

1. An electrode assembly comprising:
an electrode and a separator wound about a winding axis,
wherein the electrode includes:
a substrate including a first region in which patterns are formed and at least a portion of which is bent toward a core portion of the electrode assembly, and a second region forming a boundary with the first region in a winding direction, and
a mixture layer formed on the second region.

2. The electrode assembly of claim 1, wherein the patterns include a plurality of grooves formed into a surface of the substrate.

3. The electrode assembly of claim 1, wherein the first region includes a plurality of notches each extending in a direction perpendicular to the winding axis and having widths in the winding direction, and
wherein at least some of the notches are bent toward the core portion.

4. The electrode assembly of claim 3, wherein the plurality of notches include:
a plurality of first notches adjacent to the core portion and each having a first width in the winding direction,
a plurality of second notches each having a second width in the winding direction that is greater than the first width, and
a plurality of third notches adjacent to an outermost portion of the electrode and each having a third width greater in the winding direction that is greater than the second width.

5. The electrode assembly of claim 4, wherein a spacing between the patterns in the second notches is greater than a spacing between the patterns in the first notches, and a spacing between the patterns in the third notches is greater than a spacing between the patterns in the second notches.

6. The electrode assembly of claim 3, wherein the patterns in each of notches is 50% or more and 75% or less of an area of the notch.

7. The electrode assembly of claim 3, wherein each of the patterns is formed in a region corresponding to ½ or less of a total area from an end portion of each of the notches to the boundary.

8. The electrode assembly of claim 1, wherein the first region includes a standing portion extending in a direction of the winding axis, and a bent portion connected to the standing portion and extending in a different direction from the standing portion, and
wherein the patterns are formed on the bent portion.

9. The electrode assembly of claim 1, wherein the patterns are formed on at least one of the substrate and the mixture layer.

10. The electrode assembly of claim 1, wherein the electrode further includes an insulating layer formed on the mixture layer along the boundary, and
wherein the patterns are formed on at least one of the substrate, the mixture layer, and the insulating layer.

11. The electrode assembly of claim 10, wherein a density of the patterns is greater in at least one of the substrate and the mixture layer than a density of the patterns in the insulating layer.

12. The electrode assembly of claim 1, wherein the patterns are formed by at least one of a rolling process, a laser process, and a heat treatment process.

13. A secondary battery comprising:
a case; and
an electrode assembly accommodated in the case, the electrode assembly comprising an electrode and a separator wound about a winding axis;
an electrolyte impregnated into the electrode assembly,
wherein the electrode includes:
a substrate including a first region in which patterns are formed and at least a portion of which is bent toward a core portion of the electrode assembly, and a second region forming a boundary with the first region in a winding direction, and
a mixture layer formed in the second region.

14. The secondary battery of claim 13, wherein the patterns include a plurality of grooves formed into a surface of the substrate, and
wherein the electrolyte forms a contact angle of less than 90° with the substrate in each of the grooves.

15. The secondary battery of claim 13, wherein the first region includes a plurality of notches extending in a direction perpendicular to the winding axis and having widths in the winding direction, and
wherein at least some of the notches are bent toward the core portion.

16. The secondary battery of claim 15, wherein the plurality of notches include:
a plurality of first notches adjacent to the core portion and each having a first width in the winding direction,
a plurality of second notches each having a second width in the winding direction that is greater than the first width, and
a plurality of third notches adjacent to an outermost portion of the electrode and each having a third width greater in the winding direction than the second width.

17. The secondary battery of claim 16, further comprising a current collector located at a side of the electrode assembly, the current collector being electrically connected to the substrate and configured to collect current from the electrode,
wherein the current collector is joined to the second notches.

18. The secondary battery of claim 15, wherein the patterns in each of the notches is 50% or more and 75% or less of an area of the notch.

19. The secondary battery of claim 15, wherein each of the patterns is formed in a region corresponding to ½ or less of a total area from an end portion of each of the plurality of notches to the boundary.

20. The secondary battery of claim 13, wherein the first region includes a standing portion extending in a direction of the winding axis, and a bent portion connected to the standing portion and extending in a different direction from the standing portion, and
wherein the patterns are formed on the bent portion.
